(19) United States
(12) Patent Application Publication
(10) Pub. No.: US 2016/0257911 A1
(43) Pub. Date: Sep. 8, 2016

(54) COMPOSITIONS AND METHODS FOR CLEANING A SURFACE AND OTHER APPLICATIONS

(71) Applicant: Flotek Chemistry, LLC, Marlow, OK (US)

(72) Inventors: Don Denison, Spring, TX (US); Monica Smith-Gonzalez, The Woodlands, TX (US)

(73) Assignee: Flotek Chemistry, LLC, Marlow, OK (US)

(21) Appl. No.: 14/695,657

(22) Filed: Apr. 24, 2015

Related U.S. Application Data
(60) Provisional application No. 62/129,621, filed on Mar. 6, 2015.

(51) Int. Cl. C11D 3/20; C09K 8/524; C11D 3/18

(52) U.S. Cl. CPC C11D 3/2093; C11D 3/185; C09K 8/524

(57) ABSTRACT

Compositions and methods for cleaning a surface are generally provided. In some embodiments, a fluid comprising a solvent and a second component is provided. In some cases, the solvent is a terpene. The fluid generally has a flash point of at least about 140 ° F. In some cases, second component comprises an unsaturated alkyl ester at least 10 carbons in length. In certain embodiments, the method comprises contacting a surface with the fluid to remove heavy oil and/or asphaltenes from the surface.

### RELATED APPLICATIONS

This application claims priority to U.S. Provisional Application No. 62/129,621, filed Mar. 6, 2015, which is incorporated herein by reference in its entirety.

### FIELD OF INVENTION

Compositions and methods for cleaning of a surface are generally provided.

### BACKGROUND OF INVENTION

Solvents such as citrus and/or pine derived terpenes are widely used as additives for industrial and commercial purposes. However, due to the high volatility of these compounds, their uses are restricted by federal and state regulations. For example, commercial oilfield applications that utilize such solvents generally require special care and handling due to the inherent flammability.

Accordingly, although a number of solvents are known in the art, there is a continued need for more effective solvents for various applications that are generally environmentally friendly, safe to handle, and which meet government regulations.

### SUMMARY OF INVENTION

Compositions and methods for cleaning of a surface are generally provided.

In one aspect, fluid are provided. In some embodiments, the fluid comprises a terpene and a second component comprising a structure as in Formula (I):

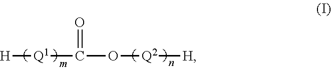

wherein each Q¹ and Q² are the same or different and are selected from the group consisting of optionally substituted alkylenes, optionally substituted alkenylenes, optionally substituted alkynylenes, optionally substituted heteroalkylenes, optionally substituted arylenes, and optionally substituted heteroarylenes, wherein the second component has a degree of unsaturation between 0-17, wherein m is 4-33, n is 1-10, and m+n is 9-3, wherein the fluid comprises X wt % of the second component versus the total fluid weight, wherein X is between about 50 and about 99, wherein the fluid comprises (100-X) wt % of the terpene versus the total fluid weight, and wherein the fluid has a flash point of at least about 140° F.

In another aspect, compositions are provided. In some embodiments, the composition comprises the fluid comprising a terpene and a second component comprising a structure as in Formula (I):

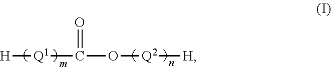

wherein each Q¹ and Q² are the same or different and are selected from the group consisting of optionally substituted alkylenes, optionally substituted alkenylenes, optionally substituted alkynylenes, optionally substituted heteroalkylenes, optionally substituted arylenes, and optionally substituted heteroarylenes, wherein the second component has a degree of unsaturation between 0-17, wherein m is 4-33, n is 1-10, and m+n is 9-3, wherein the fluid comprises X wt % of the second component versus the total fluid weight, wherein X is between about 50 and about 99, wherein the fluid comprises (100-X) wt % of the terpene versus the total fluid weight, and wherein the fluid has a flash point of at least about 140° F., and one or more additives.

In another aspect, methods are provided. In some embodiments, the method comprises contacting a surface associated with an hydrocarbon with a fluid comprising a terpene and a second component comprising a structure as in Formula (I):

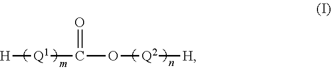

wherein each Q¹ and Q² are the same or different and are selected from the group consisting of optionally substituted alkylenes, optionally substituted alkenylenes, optionally substituted alkynylenes, optionally substituted heteroalkylenes, optionally substituted arylenes, and optionally substituted heteroarylenes, wherein the second component has a degree of unsaturation between 0-17, wherein m is 4-33, n is 1-10, and m+n is 9-3, wherein the fluid comprises X wt % of the second component versus the total fluid weight, wherein X is between about 50 and about 99, wherein the fluid comprises (100-X) wt % of the terpene versus the total fluid weight, and wherein the fluid has a flash point of at least about 140° F., such that the hydrocarbon disassociates from the surface.

Other aspects, embodiments, and features of the methods and compositions will become apparent from the following detailed description when considered in conjunction with the accompanying drawings. All patent applications and patents incorporated herein by reference are incorporated by reference in their entirety. In case of conflict, the present specification, including definitions, will control.

### BRIEF DESCRIPTION OF THE DRAWINGS

FIG. 1 is an exemplary plot of flash point as a function of solvent composition, according to a non-limiting set of embodiments;

FIGS. 2A-2B are exemplary plots of asphaltene dispersion in the presence of various solvents and solvent compositions, according to a non-limiting set of embodiments.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

Compositions and methods for cleaning of a surface are generally provided. In some embodiments, the composition is a fluid. The fluid generally comprises a solvent (e.g., a terpene) and a second component In some embodiments, the second component is an ester of a fatty acid of at least 10 carbons in length. In certain embodiments, the second component has a degree of unsaturation of between 0-17. In some cases, the second component is present in the fluid in an amount of greater than or equal to 50 wt % (e.g., the solvent such as terpene is present in the fluid in an amount of less than or equal to 50 wt %). The fluid (e.g., a fluid comprising a terpene and an additional second component) generally has a flash point of at least about 140° F. The compositions described herein may be provided for treating oil and/or gas wells, reservoirs, wellbores, casings, pipelines and storage equipment, or related equipment (e.g., tools, truck beds, asphaltene paving equipment), and may remove hydrocarbon compounds (e.g., petroleum residues, asphaltenes, tars, heavy oils) from a surface.

Solvents such as terpenes are generally used alone or as additives for industrial and commercial purposes (e.g., surface cleaning). However, due to the high volatility of these solvents, their use is typically restricted by federal and state regulations. Therefore, commercial applications (e.g., in oil fields, etc.) that utilize such solvents to generally require special handling procedures (e.g., due to the inherent flammability of the solvents). The fluids described herein (e.g., comprising a terpene and an second component) offer several advantages over traditional solvents or cleaning compositions (e.g., solvents used for cleaning surfaces and/or removing hydrocarbon compounds such as asphaltenes, tar and heavy oils from a surface), including having higher flash points (e.g., greater than 140° F.), having low or substantially no volatile organic compounds (VOCs), and increased safety considerations, resulting in significantly more uses and applications for these fluids (e.g., without requiring special handling or care). The term volatile organic compound generally refers to organic compounds which have relatively high vapor pressures at room temperature and may be regulated by, for example, the United States Environment Protection Agency. Additionally, the second component described herein offers several advantages over other additives typically added to solvents, including increasing the flash point of the solvent, and increased solvency with the solvent. The fluids (e.g., fluid comprising a terpene and a second component) described herein are generally biodegradable, bio-derived from renewable sources, environmentally friendly, non-toxic, meet or exceed government regulation requirements, and/or are safe to handle. The fluid described herein may also be used in application where traditional solvents (e.g., BTEX solvents or terpene solvents) cannot be used to due high flash point requirements and/or VOC requirements.

As described above, the fluid generally comprises a solvent (e.g., a terpene) and a second component. In some embodiments, the second component is an ester of a fatty acid of at least 10 carbons in length. In some embodiments, the second component comprises a structure as in Formula (I):

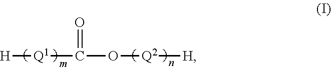

wherein each Q¹ and Q² are the same or different and are selected from the group consisting of optionally substituted alkylenes, optionally substituted heteroalkylenes, optionally substituted arylenes, optionally substituted heteroarylenes, optionally substituted alkenylenes, and optionally substituted alkynylenes, n is 1-10, and m is 4-33, provided m+n is 9-34. In some embodiments, each Q¹ and Q² are the same or different and are selected from the group consisting of optionally substituted alkylenes, optionally substituted alkenylenes, optionally substituted alkynylenes, and optionally substituted arylenes. In some embodiments, each Q¹ and Q² are the same or different and are selected from the group consisting of optionally substituted alkylenes, optionally substituted alkenylenes, and optionally substituted alkynylenes. In certain embodiments, each Q¹ and Q² is the same or different and is —CH₂—, —CH((CH₂)ₓH)—, —CH═CH—, —C≡C—, or arylene, wherein x is 1-10. In certain embodiments, each Q¹ and Q² is the same or different and is —CH₂—, —CH((CH₂)ₓH)—, —CH═CH—, or —C≡C—, wherein x is 1-10. In some embodiments, the second component comprising the structure as in Formula (I) is not substituted with nitrogen and/or alcohol functional groups.

In some embodiments, a second component comprising the structure as in Formula (I) has a backbone length of 10-35 carbons (i.e. a total carbon length of 10-35 carbons). That is to say, the total number of carbons in the backbone of the composition is between 9 and 36 carbons. The term backbone is given its typical meaning in the art and generally refers to a series of covalently bound atoms that together create a continuous chain forming the compound, and generally does not refer to any side chains (e.g., branches). In some embodiments, for a second component comprising the structure as in Formula (I), m is 4-33 and n is 1-10. For example, in certain embodiments, m is 4-33, or 4-8, or 6-10, or 8-20, or 15-25, or 18-30, or 20-33. In some embodiments, n is 1-10, or 1-3, or 2-4, or 4-8, or 6-10. Combinations of the above-referenced ranges are also possible (e.g., m is 4-33 and n is 1-10, or m is 4-8 and n is 1-3, or m is 18-30 and n is 2-4). In some embodiments, m+n is 9-34, or 10-18, or 15-20, or 18-30. In certain embodiments, m+n is 25.

In some embodiments, the second component comprising the structure as in Formula (I) is saturated. That is to say, in certain embodiments, the second component does not comprise any unsaturated carbon groups (e.g., carbon-carbon double bonds, carbon-carbon triple bonds, and aromatic groups). For example, in some embodiments, each Q¹ and Q² are the same and comprise an alkylene (e.g., —CH₂—). In an exemplary embodiment, the second component is a saturated alkyl ester (e.g., saturated alkyl methyl ester), comprising the structure as in Formula (II):

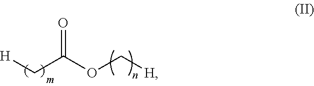

wherein each Q¹ and Q² are —CH₂—, m is 4-33 and n is 1-10. For example, the second component may be a saturated alkyl methyl ester, wherein n is 1. In some embodiments, m is 17 and n is 1, and the second component comprises a structure as in Formula (III):

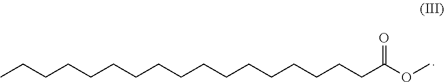 [SMILES: CCCCCCCCCCCCCCCCCC(=O)OC]

In another exemplary embodiment, the second component may be a saturated alkyl ethyl ester, wherein n is 2. In some embodiments, m is 17 and n is 2, and the second component comprises a structure as in Formula (IV):

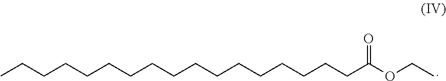 [SMILES: CCCCCCCCCCCCCCCCCC(=O)OCC]

In some embodiments, the second component may branched. For example, in some embodiments, each Q¹ and Q² are the same or different and are —CH₂— or —CH((CH₂)ₓH)—, wherein x is 1-10. In certain embodiments, x is 1-2, or 2-4, or 3-6, or 4-8, or 6-10.

In an exemplary embodiment, the second component may comprise the structure as in Formula (V):

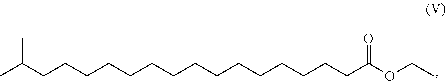 [SMILES: CCOC(=O)CCCCCCCCCCCCCCCC(C)C]

such that each Q¹ and Q² are the same or different and are —CH₂— or —CH((CH₂)ₓH)—, m is 17, n is 2, and x is 1.

In another exemplary embodiment, the second component may comprise the structure as in Formula (VI) (e.g., an alkyl ethylhexyl ester):

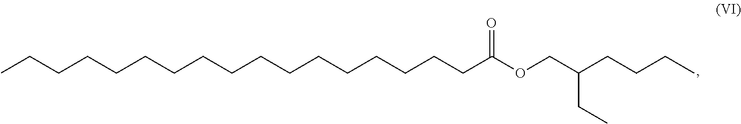 [SMILES: CCCCCCCCCCCCCCCCCC(=O)OCC(CC)CCCC]

such that each Q¹ and Q² are the same or different and are —CH₂— or —CH((CH₂)ₓH)—, m is 17, n is 6, and x is 2.

Those skilled in the art will understand that while values of m, n, and x are provided above, these are by way of example only and that other values of m, n, and x, as well as different arrangements of each of Q¹ and Q², are also possible.

In some embodiments, at least one of Q¹ and/or Q² comprise an unsaturated carbon group. Non-limiting examples of unsaturated carbon groups include carbon-carbon double bonds, carbon-carbon triple bonds, and aromatic groups (e.g., an arylene). In some embodiments, the second component comprises a particular degree of unsaturation. The term “degree of unsaturation” generally refers to the number of unsaturated carbon groups present in the second component. For example, in some embodiments, the second component has 0-17 degrees of unsaturation. That is to say, in some such embodiments, 0-17 of Q¹ and Q² are the same or different and are —CH═CH—, —C≡C—, or arylene. In some embodiments, the second component (e.g., a second component comprising a structure as in Formula (I)) has 0-17, 1-15, 5-15, 1-3, 2-4, 4-8, 6-11, or 8-17 degrees of unsaturation. In certain embodiments, the composition has at least 1 degree, at least 2 degrees, at least 3 degrees, at least 4 degrees, at least 6 degrees, at least 8 degrees, or at least 10 degrees of unsaturation. In some embodiments, the composition has 11 degrees of unsaturation. Other degrees of unsaturation are also possible.

In an exemplary embodiment, the second component is an unsaturated alkyl methyl ester (e.g., an unsaturated alkyl methyl ester having 3 degrees of unsaturation). For example, the second component may have a structure as in Formula (VII):

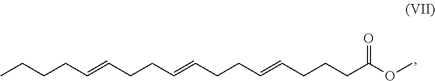 [SMILES: CCCC/C=C/CC/C=C/CC/C=C/CCCC(=O)OC]

such that each Q¹ and Q² are the same or different and —CH₂— or —CH═CH—, m is 14 and n is 1.

In another exemplary embodiments, the second component is an unsaturated alkyl methyl ester having 6 degrees of unsaturation. For example, the second component may have a structure as in Formula (VIII):

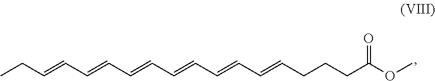 [SMILES: CC/C=C/C=C/C=C/C=C/C=C/C=C/CCCC(=O)OC]

such that each Q¹ and Q² are the same or different and —CH₂— or —CH═CH—, m is 11 and n is 1.

In some embodiments, the second component is a terminally unsaturated alkyl ester. In an exemplary embodiment, the second component has 1 degree of unsaturation and is terminally unsaturated. For example, the second component may have a structure to as in Formula (IX):

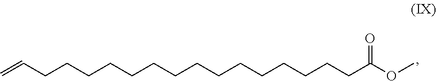 [SMILES: C=CCCCCCCCCCCCCCCCC(=O)OC]

such that each Q¹ and Q² are the same or different and —CH₂— or —CH═CH—, m is 16 and n is 1.

In certain embodiments, the second component comprises one or more carbon-carbon triple bonds. In an exemplary embodiment, the second component has 1 degree of unsaturation. For example, the second component may have a structure as in Formula (X):

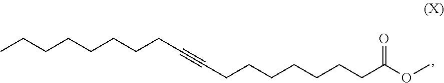 [SMILES: CCCCCCCCC#CCCCCCCCC(=O)OC]

such that each Q¹ and Q² are the same or different and —CH₂— or —C≡C—, m is 16 and n is 1.

Those skilled in the art will understand that Formulas (III)-(X) are by way of example only and that other values of Q¹, Q², m, n, x, and degrees of unsaturation are also possible, as described in more detail above.

In some embodiments, the second component s a fatty acid ester formed by transesterification of a fatty acid. Fatty acids generally comprise a carboxylic acid with an aliphatic tail, which is either saturated or unsaturated. Non-limiting examples of fatty acids include one or more saturated fatty acids, monounsaturated fatty acids, and polyunsaturated fatty acids. In some embodiments, the fatty acid is a polyunsaturated fatty acid. In some embodiments, the fatty acid is a conjugated polyunsaturated fatty acid. Non-limiting examples of fatty acids include myristoleic acid, oleic acid, palmitoleic acid, cis-vaccenic acid, gadoleic acid, erucic acid, nervonic acid, ricinoleic acid, linoleic acid, linolenic acid, eleostearic acid, eicosenoic acid, and erucic acid. Those skilled in the art would be familiar with methods for transesterification of fatty acids including, for example, reaction of a fatty acid with an alcohol.

In some embodiments, the second component s bioderived (e.g., 100% bioderived). In an exemplary embodiments, the second component is an alkyl methyl ester derived from palm oil. In some embodiments, the second component is essentially free of VOCs (e.g., less than about 5 wt % VOCs, or less than about 1 wt % VOCs, or less than about 0.1 wt % VOCs versus the total composition). Those skilled in the art would be capable of selecting suitable methods for determining the VOC content of a fluid including, for example, EPA Method 24. Briefly, following ASTM D2369, about 3 mL of sample is added to an aluminum foil weighing dish and weighed. Following heating of the sample to about 110° C. for 1 hour, the sample and dish are weighed again, where the difference in weight is the VOC content of the original sample (e.g., the weight fraction of VOCs is the difference between the weight of the dish and sample before heating and the weight of the dish and sample after heating, divided by the weight of the sample).

The second component (e.g., comprising a structure as in Formula (I)) is generally present in the fluid in an amount ranging between about 50 wt % and about 99 wt % versus the total fluid composition. For example, in some embodiments, the second component is present in the fluid in an amount of greater than or equal to about 50 wt %, greater than or equal to about 60 wt %, greater than or equal to about 70 wt %, greater than or equal to about 75 wt %, greater than or equal to about 80 wt %, greater than or equal to about 90 wt %, greater than or equal to about 95 wt %, or greater than or equal to about 98 wt % versus the total fluid composition. In certain embodiments, the second component is present in the composition in an amount of less than about 99 wt %, less than about 98 wt %, less than about 95 wt %, less than about 90 wt %, less than about 80 wt %, less than about 75 wt %, less than about 70 wt %, or less than about 60 wt % versus the total fluid composition. Combinations of the above-referenced ranges are also possible (e.g., between about 50 wt % and about 99 wt %, between about 50 wt % and about 75 wt %, between about 60 wt % and about 80 wt %, or between about 70 wt % and about 90 wt %).

Any suitable solvent may be utilized in the fluids. The solvent, or a combination of solvents, may be present in the fluid in any suitable amount. In certain embodiments, the solvent (e.g., a terpene) is present in the fluid in an amount between about 1 wt % and 50 wt % versus the total fluid composition. For example, in some embodiments, the solvent is present in the fluid in an amount of greater than or equal to about 1.0 wt %, greater than or equal to about 5.0 wt %, greater than or equal to about 10.0 wt %, greater than or equal to about 20.0 wt %, or greater than or equal to about 40.0 wt %, versus the total fluid composition. In certain embodiments, the solvent is present in the fluid in an amount of less than about 50.0 wt %, less than about 20.0 wt %, less than about 10.0 wt %, to less than about 5.0 wt %, or less than about 2.0 wt %. Combinations of the above-referenced ranges are also possible (e.g., between about 1 wt % and about 50 wt %, between about 25 wt % and about 50 wt %, between about 20 wt % and about 40 wt %, or between about 10 wt % and about 30 wt %).

In certain embodiments, the weight percent of the solvent (e.g., a terpene) and the second component yields about 100 wt % of the total fluid composition. That is to say, in some embodiments, the second component is present in the fluid an amount ranging between about 50 wt % and about 99 wt % and the remainder of the fluid consists essentially of the solvent (e.g., ranging between about 1 wt % and about 50 wt %). For example, in some embodiments the second component is present in the fluid in an amount of about X wt % and the solvent is present in the fluid in an amount of about 100-X wt %, where X is between about 50 and about 99. In some embodiments, X is greater than or equal to about 50, greater than or equal to about 60, greater than or equal to about 70, greater than or equal to about 80, greater than or equal to about 90, greater than or equal to about 95, or greater than or equal to about 98. In certain embodiments, X is less than about 99, less than about 98, less than about 95, less than about 90, less than about 80, less than about 70, or less than about 60. Combinations of the above-referenced ranges are also possible (e.g., between about 50 and about 99, between about 60 and about 80, between about 70 and about 90). In some embodiments, the fluid consists essentially of the solvent (e.g., terpene) and the second component. In some embodiments, the fluid consists of the solvent (e.g., terpene) and the second component. It should be understood, however, that in some embodiments, the solvent may comprises a first type of solvent and a second type of solvent, and the second component may comprises a first type of the second component (e.g., a first compound having a structure as in Formula (I)) and a second type of the second component (e.g., a second compound having a structure as in Formula (I) that differs from the first compound having a structure as in Formula (I)).

Those of ordinary skill in the art will appreciate that more than one type of solvent may be utilized in the fluids described herein. For example, the fluid may comprise more than one or two types of solvent, for example, three, four, five, six, or more, types of solvents. In some embodiments, the fluid comprises a first type of solvent and a second type of solvent. The first type of solvent to the second type of solvent ratio in a fluid may be present in any suitable ratio. In some embodiments, the ratio of the to first type of solvent to the second type of solvent by weight is between about 4:1 and 1:4, or between 2:1 and 1:2, or about 1:1.

In certain embodiments, the solvent comprises a terpene. Terpenes may be generally classified as monoterpenes (e.g., having two isoprene units), sesquiterpenes (e.g., having 3 isoprene units), diterpenes, or the like. The term terpenoid also includes natural degradation products, such as ionones, and natural and synthetic derivatives, e.g., terpene alcohols, aldehydes, ketones, acids, esters, epoxides, and hydrogenation products (e.g., see Ullmann's Encyclopedia of Industrial Chemistry, 2012, pages 29-45, herein incorporated by reference). It should be understood, that while much of the description herein focuses on terpenes, this is by no means limiting, and terpenoids may be employed where appropriate. In some cases, the terpene is a naturally occurring terpene. In some cases, the terpene is a non-naturally occurring terpene and/or a chemically modified terpene (e.g., saturated terpene, terpene amine, fluorinated terpene, or silylated terpene).

In some embodiments, the terpene is a monoterpene. Monoterpenes may be further classified as acyclic, monocyclic, and bicyclic as well as whether the monoterpene comprises one or more oxygen atoms (e.g., alcohol groups, ester groups, carbonyl groups, etc.). In some embodiments, the terpene is an oxygenated terpene, for example, a terpene comprising an alcohol, an aldehyde, and/or a ketone group. In some embodiments, the terpene comprises an alcohol group. Non-limiting examples of terpenes comprising an alcohol group are linalool, geraniol, nopol, α-terpineol, and menthol. In some embodiments, the terpene comprises an ether-oxygen, for example, eucalyptol, or a carbonyl oxygen, for example, menthone.

Non-limiting examples of terpenes include linalool, geraniol, pinene, nopol, α-terpineol, menthol, eucalyptol, menthone, d-limonene, terpinolene, β-occimene, γ-terpinene, α-pinene, and citronellene. In a particular embodiment, the terpene is selected from the group consisting of α-terpeneol, α-pinene, nopol, and eucalyptol. In one embodiment, the terpene is pinene. In another embodiment, the terpene is d-limonene.

In some embodiments, the terpene is a non-naturally occurring terpene and/or a chemically modified terpene (e.g., saturated terpene). In some cases, the terpene is a partially or fully saturated terpene (e.g., p-menthane, pinane). In some cases, the terpene is a non-naturally occurring terpene. Non-limiting examples of non-naturally occurring to terpenes include, menthene, p-cymene, r-carvone, terpinenes (e.g., alpha-terpinenes, beta-terpinenes, gamma-terpinenes), dipentenes, terpinolenes, borneol, alpha-terpinamine, and pine oils.

In certain embodiments, the solvent utilized in the fluid described herein may comprise one or more impurities. For example, in some embodiments, a solvent is extracted from a natural source (e.g., citrus, pine), and may comprise one or more impurities present from the extraction process. In some embodiments, the solvent comprises a crude cut (e.g., uncut crude oil, for example, made by settling, separation, heating, etc.). In some embodiments, the solvent is a crude oil (e.g., naturally occurring crude oil, uncut crude oil, crude oil extracted from the wellbore, synthetic crude oil, crude citrus oil, crude pine oil, eucalyptus, etc.). In some embodiments, the solvent is a citrus extract (e.g., crude orange oil, orange oil, etc.).

In some embodiments, the fluid comprising the solvent (e.g., a terpene) and the second component (e.g., comprising a structure as in Formula (I)) comprises less than about 50 wt % of volatile organic compounds (VOCs), less than about 40 wt % VOCs, less than about 30 wt % VOCs, less than about 20 wt % VOCs, less than about 10 wt % VOCs, less than about 5 wt % VOCs, or less than about 1 wt % VOCs versus the total fluid weight.

In some embodiments, the fluid may be characterized in terms of a flash point. The term flash point is given its ordinary meaning in the art and generally refers to the lowest temperature at which a particular compound or fluid gives off sufficient vapor to form an ignitable mixture in air.

In some embodiments, the fluid comprising the second component (e.g., a second component comprising a structure as in Formula (I)) and the solvent (e.g., a terpene) has a flash point of at least about 140° F. For example, in certain embodiments, the fluid has a flash point of at least about 140° F., at least about 150° F., at least about 170° F., at least about 190° F., at least about 210° F., or at least about 230° F. In some embodiments, the fluid has a flash point of less than or equal to about 250° F., less than or equal to about 230° F., less than or equal to about 210° F., less than or equal to about 190° F., less than or equal to about 170° F., or less than or equal to about 150° F. Combinations of the above-referenced ranges are also possible (e.g., between about 140° F. and about 250° F., between about 140° F. and about 190° F., between about 170° F. and about 230° F., between about 210° F. and about 250° F.). Other ranges are also possible.

Those skilled in the art would be capable of selecting suitable methods for determining the flash point of the fluid including, for example, open cup and closed cup (e.g., ASTM method D7094) methods. For example, the flash point may be determined, in some embodiments, by providing a fluid comprising about 60 wt % of a second component (e.g., a second component comprising a structure as in Formula (I)) and about 40 wt % a solvent (e.g., a terpene) in and heating the fluid in a closed container while and an ignition source is directed into the cup at regular intervals (i.e. as the temperature of the fluid increases) until a flash that spreads throughout the inside of the cup is seen. The corresponding minimum temperature at which the flash occurs is generally considered the flash point of the fluid.

In some embodiments, the fluid (e.g., comprising a second component comprising a structure as in Formula (I) and a solvent such as a terpene) may be incorporated into a composition.

In some embodiments, the composition may include a dilution fluid (e.g., a dilution fluid and the fluid described herein). Non-limiting examples of suitable dilution fluids include water, salt water, brine, produced water, and potassium chloride (e.g., about 2 wt % potassium chloride).

In certain embodiments, the composition comprises an emulsion and/or microemulsion. In some such embodiments, the fluids described herein may be incorporated into an already formed emulsion and/or microemulsion. In some embodiments, the fluids described herein may be employed as a portion or all of the organic phase of an emulsion and/or microemulsion.

Non-limiting examples of suitable emulsions and microemulsions for use with the fluids described herein are described in U.S. patent application Ser. No. 13/829,495, filed Mar. 14, 2013, entitled “Methods And Compositions For Stimulating The Production Of Hydrocarbons From Subterranean Formations;” U.S. patent application Ser. No. 13/829,434, filed Mar. 14, 2013, entitled “Methods And Compositions For Stimulating The Production Of Hydrocarbons From Subterranean Formations;” U.S. patent application Ser. No. 13/918,155, filed Jun. 14, 2013, “Methods And Compositions For Stimulating The Production Of Hydrocarbons From Subterranean Formations;” U.S. patent application Ser. No. 13/918,166, filed Jun. 14, 2013, “Methods And Compositions For Stimulating The Production Of Hydrocarbons From Subterranean Formations;” U.S. patent application Ser. No. 14/212,731, filed to Mar. 14, 2014, entitled “Methods And Compositions For Use In Oil and/or Gas Wells;” and U.S. Pat. No. 7,380,606, issued Jun. 3, 2008, entitled “Composition And Process For Well Cleaning,” incorporated herein by reference in their entirety. The fluids added to an emulsion or microemulsion may increase the flash point of the emulsion or microemulsion, as compared to the flash point of the emulsion or microemulsion alone. For example, in some embodiments, the emulsion or microemulsion comprises between about 1 wt % and about 25 wt % of the fluid (e.g., comprising a second component comprising a structure as in Formula (I) and a solvent such as a terpene) and between about 75 wt % and about 99 wt % of an emulsion and/or microemulsion versus the total composition.

Those skilled in the art would understand that the desired properties described herein (e.g., having a flash point of at least about 140° F.) generally refer to composition comprising the solvent (e.g., terpene) and second component (e.g., having a structure as in Formula (I)), but may also apply to diluted forms of the composition, as described above.

As noted above, in some embodiments, the fluid consists or consists essentially of the solvent and the second component. However, in other embodiments, a composition is provided comprising the fluid and one or more additives. In certain embodiments, the one or more additives comprise one or more surfactants, one or more co-solvents, one or more alcohols, one or more paraffin dispersants, or combinations thereof. In some embodiments, the one or more additives are present in the composition (e.g., the composition comprising the fluid and the one or more additives) in an amount ranging between 0.1 wt % and about 75 wt % versus the total composition weight. In a particular embodiment, the composition comprises between about 50 wt % and 99 wt % the second component, between about 0.1 wt % and about 75 wt % the additive, and the remainder of the fluid consists essentially of the solvent (e.g., ranging between about 0.9 wt % and about 49.9 wt %). In certain embodiments, essentially no additives are present in the composition (e.g., the composition comprising the fluid consisting essentially of the solvent and the second component). In some cases, the one or more additives are present in the composition in an amount of at least about 0.01 wt %, at least about 0.05 wt %, at least about 0.1 wt %, at least about 0.5 wt %, at least about 1 wt %, at least about 5 wt %, at least about 10 wt %, at least about 15 wt %, at least about 20 wt %, at least about 25 wt %, at least about 30 wt %, at least about 50 wt %, or at least about 60 wt % versus the to total composition weight. In certain embodiments, the one or more additives are present in the composition in an amount less than or equal to about 75 wt %, less than or equal to about 60 wt %, less than or equal to about 50 wt %, less than or equal to about 30 wt %, less than or equal to about 25 wt %, less than or equal to about 20 wt %, less than or equal to about 15 wt %, less than or equal to about 10 wt %, less than or equal to about 5 wt %, less than or equal to about 1 wt %, less than or equal to about 0.5 wt %, or less than or equal to about 0.1 wt % versus the total composition weight. Combinations of the above-reference ranges are also possible (e.g., between about 0.1 wt % and about 75 wt %, between about 0.1 wt % and about 25 wt %, between about 0.1 wt % and about 15 wt %). Other ranges are also possible. For example, in an exemplary embodiments, the composition comprises the fluid and between 0 wt % and about 75 wt % one or more surfactants, between 0 wt % and about 25 wt % one or more alcohols, and/or between 0 wt % and about 15 wt % one or more paraffin dispersants.

In some embodiments, the one or more additives comprises a surfactant. The surfactant may comprise a single surfactant or a combination of two or more surfactants. For example, in some embodiments, the surfactant comprises a first type of surfactant and a second type of surfactant. The term surfactant, as used herein, is given its ordinary meaning in the art and refers to compounds having an amphiphilic structure which gives them a specific affinity for oil/water type and water/oil type interfaces which helps the compounds to reduce the free energy of these interfaces. The term surfactant encompasses cationic surfactants, anionic surfactants, amphoteric surfactants, nonionic surfactants, zwitterionic surfactants, and mixtures thereof. In some embodiments, the surfactant is a nonionic surfactant. Nonionic surfactants generally do not contain any charges. Amphoteric surfactants generally have both positive and negative charges, however, the net charge of the surfactant can be positive, negative, or neutral, depending on the pH of the solution. Anionic surfactants generally possess a net negative charge. Cationic surfactants generally possess a net positive charge. Zwitterionic surfactants are generally not pH dependent. A zwitterion is a neutral molecule with a positive and a negative electrical charge, though multiple positive and negative charges can be present. Zwitterions are distinct from dipole, at different locations within that molecule. The term surface energy, as used herein, is given its ordinary meaning in the art and refers to the extent of disruption of intermolecular bonds that occur when the surface is created (e.g., the energy excess associated with the surface as compared to the bulk). Generally, surface energy is also referred to as surface tension (e.g., for liquid-gas interfaces) or interfacial tension (e.g., for liquid-liquid interfaces). As will be understood by those skilled in the art, surfactants generally orient themselves across the interface to minimize the extent of disruption of intermolecular bonds (i.e. lower the surface energy). Typically, a surfactant at an interface between polar and non-polar phases orient themselves at the interface such that the difference in polarity is minimized Those of ordinary skill in the art will be aware of methods and techniques for selecting surfactants for use as an additive as described herein. In some cases, the surfactant(s) are matched to and/or optimized for the particular oil or solvent in use.

Non-limiting examples of surfactants for use with the compositions and methods described herein will be known in the art. In some embodiments, the surfactant is an alkyl polyglycol ether, for example, having 2-250 ethylene oxide (EO) (e.g., or 2-200, or 2-150, or 2-100, or 2-50, or 2-40) units and alkyl groups of 4-20 carbon atoms. In some embodiments, the surfactant is an alkylaryl polyglycol ether having 2-250 EO units (e.g., or 2-200, or 2-150, or 2-100, or 2-50, or 2-40) and 8-20 carbon atoms in the alkyl and aryl groups. In some embodiments, the surfactant is an ethylene oxide/propylene oxide (EO/PO) block copolymer having 2-250 EO or PO units (e.g., or 2-200, or 2-150, or 2-100, or 2-50, or 2-40). In some embodiments, the surfactant is a fatty acid polyglycol ester having 6-24 carbon atoms and 2-250 EO units (e.g., or 2-200, or 2-150, or 2-100, or 2-50, or 2-40). In some embodiments, the surfactant is a polyglycol ether of hydroxyl-containing triglycerides (e.g., castor oil). In some embodiments, the surfactant is an alkylpolyglycoside of the general formula R″—O—Zₙ, where R″ denotes a linear or branched, saturated or unsaturated alkyl group having on average 8-24 carbon atoms and Zₙ denotes an oligoglycoside group having on average n=1-10 hexose or pentose units or mixtures thereof. In some embodiments, the surfactant is a fatty ester of glycerol, sorbitol, or pentaerythritol. In some embodiments, the surfactant is an amine oxide (e.g., dodecyldimethylamine oxide). In some embodiments, the surfactant is an alkyl sulfate, for example having a chain length of 8-18 carbon atoms, alkyl ether sulfates having 8-18 carbon atoms in the hydrophobic group and 1-40 ethylene oxide (EO) or propylene oxide (PO) units. In some embodiments, the surfactant is a sulfonate, for example, an alkyl sulfonate having 8-18 carbon atoms, an alkylaryl sulfonate having 8-18 carbon atoms, an ester or half ester of sulfosuccinic acid with monohydric alcohols or alkylphenols having 4-15 carbon atoms, or a multisulfonate (e.g., comprising two, three, to four, or more, sulfonate groups). In some cases, the alcohol or alkylphenol can also be ethoxylated with 1-250 EO units (e.g., or 2-200, or 2-150, or 2-100, or 2-50, or 2-40). In some embodiments, the surfactant is an alkali metal salt or ammonium salt of a carboxylic acid or poly(alkylene glycol) ether carboxylic acid having 8-20 carbon atoms in the alkyl, aryl, alkaryl or aralkyl group and 1-250 EO or PO units (e.g., or 2-200, or 2-150, or 2-100, or 2-50, or 2-40). In some embodiments, the surfactant is a partial phosphoric ester or the corresponding alkali metal salt or ammonium salt, e.g., an alkyl and alkaryl phosphate having 8-20 carbon atoms in the organic group, an alkylether phosphate or alkarylether phosphate having 8-20 carbon atoms in the alkyl or alkaryl group and 1-250 EO units (e.g., or 2-200, or 2-150, or 2-100, or 2-50, or 2-40). In some embodiments, the surfactant is a salt of primary, secondary, or tertiary fatty amine having 8-24 carbon atoms with acetic acid, sulfuric acid, hydrochloric acid, and phosphoric acid. In some embodiments, the surfactant is a quaternary alkyl- and alkylbenzylammonium salt, whose alkyl groups have 1-24 carbon atoms (e.g., a halide, sulfate, phosphate, acetate, or hydroxide salt). In some embodiments, the surfactant is an alkylpyridinium, an alkylimidazolinium, or an alkyloxazolinium salt whose alkyl chain has up to 18 carbons atoms (e.g., a halide, sulfate, phosphate, acetate, or hydroxide salt). In some embodiments, the surfactant is amphoteric or zwitterionic, including sultaines (e.g., cocamidopropyl hydroxysultaine), betaines (e.g., cocamidopropyl betaine), or phosphates (e.g., lecithin). Non-limiting examples of specific surfactants include a linear C₁₂-C₁₅ ethoxylated alcohols with 5-12 moles of EO, lauryl alcohol ethoxylate with 4-8 moles of EO, nonyl phenol ethoxylate with 5-9 moles of EO, octyl phenol ethoxylate with 5-9 moles of EO, tridecyl alcohol ethoxylate with 5-9 moles of EO, Pluronic® matrix of EO/PO copolymers, ethoxylated cocoamide with 4-8 moles of EO, ethoxylated coco fatty acid with 7-11 moles of EO, and cocoamidopropyl amine oxide.

In some embodiments, the surfactant is a siloxane surfactant as described in U.S. patent application Ser. No. 13/831,410, filed Mar. 14, 2014, herein incorporated by reference.

In some embodiments, the surfactant is a Gemini surfactant. Gemini surfactants generally have the structure of multiple amphiphilic molecules linked together by one or more covalent spacers. In some embodiments, the surfactant is an extended surfactant, wherein the extended surfactants has the structure where a non-ionic hydrophilic spacer to (e.g. ethylene oxide or propylene oxide) connects an ionic hydrophilic group (e.g. carboxylate, sulfate, phosphate).

In some embodiments the surfactant is an alkoxylated polyimine with a relative solubility number (RSN) in the range of 5-20. As will be known to those of ordinary skill in the art, RSN values are generally determined by titrating water into a solution of surfactant in 1,4dioxane. The RSN values is generally defined as the amount of distilled water necessary to be added to produce persistent turbidity. In some embodiments the surfactant is an alkoxylated novolac resin (also known as a phenolic resin) with a relative solubility number in the range of 5-20. In some embodiments the surfactant is a block copolymer surfactant with a total molecular weight greater than 5000 daltons. The block copolymer may have a hydrophobic block that is comprised of a polymer chain that is linear, branched, hyperbranched, dendritic or cyclic. Non-limiting examples of monomeric repeat units in the hydrophobic chains of block copolymer surfactants are isomers of acrylic, methacrylic, styrenic, isoprene, butadiene, acrylamide, ethylene, propylene and norbornene. The block copolymer may have a hydrophilic block that is comprised of a polymer chain that is linear, branched, hyper branched, dendritic or cyclic. Non-limiting examples of monomeric repeat units in the hydrophilic chains of the block copolymer surfactants are isomers of acrylic acid, maleic acid, methacrylic acid, ethylene oxide, and acrylamine.

The surfactant may be present in the composition in any suitable amount. In some embodiments, the surfactant is present in the composition in an amount ranging between 1 wt % and about 75 wt %. In some cases, the surfactant is present in the composition in an amount of at least about 1 wt %, at least about 5 wt %, at least about 10 wt %, at least about 15 wt %, at least about 20 wt %, at least about 25 wt %, at least about 30 wt %, at least about 50 wt %, or at least about 60 wt % versus the total composition weight. In certain embodiments, the surfactant is present in the composition in an amount less than or equal to about 75 wt %, less than or equal to about 60 wt %, less than or equal to about 50 wt %, less than or equal to about 30 wt %, less than or equal to about 25 wt %, less than or equal to about 20 wt %, less than or equal to about 15 wt %, less than or equal to about 10 wt %, or less than or equal to about 5 wt % versus the total composition weight. Combinations of the above-referenced ranges are also possible (e.g., between about 1 wt % and about 75 wt %, between about 10 wt % and about 25 wt %, between about 15 wt % and about 50 wt %, between about 30 wt % and about 75 wt %). Other ranges are also possible.

In some embodiments, the one or more additives comprises an alcohol. An alcohol may, for example, lower the freezing point of the composition. The additive may comprise a single alcohol or a combination of two or more alcohols. In some embodiments, the alcohol is selected from primary, secondary and tertiary alcohols having between 1 and 20 carbon atoms. In some embodiments, the alcohol comprises a first type of alcohol and a second type of alcohol. Non-limiting examples of alcohols include methanol, ethanol, isopropanol, n-propanol, n-butanol, i-butanol, sec-butanol, iso-butanol, and t-butanol. In some embodiments, the alcohol is ethanol or isopropanol. In some embodiments, the alcohol is isopropanol.

The alcohol may be present in the composition in any suitable amount. In some embodiments, the alcohol is present in the composition in an amount ranging between 0.01 wt % and about 25 wt %. In some cases, the alcohol is present in the composition in an amount of at least about 0.01 wt %, at least about 0.05 wt %, at least about 0.1 wt %, at least about 0.5 wt %, at least about 1 wt %, at least about 5 wt %, at least about 10 wt %, at least about 15 wt %, or at least about 20 wt % versus the total composition weight. In certain embodiments, the alcohol is present in the composition in an amount less than or equal to about 25 wt %, less than or equal to about 20 wt %, less than or equal to about 15 wt %, less than or equal to about 10 wt %, less than or equal to about 5 wt %, less than or equal to about 1 wt %, less than or equal to about 0.5 wt %, or less than or equal to about 0.1 wt % versus the total composition weight. Combinations of the above-reference ranges are also possible (e.g., between about 0.1 wt % and about 25 wt %, between about 0.1 wt % and about 15 wt %, between about 10 wt % and about 25 wt %). Other ranges are also possible.

In some embodiments, the one or more additives comprises a paraffin dispersant. Non-limiting examples of paraffin dispersants include active acidic copolymers, active alkylated polyester, active alkylated polyester amides, active alkylated polyester imides, aromatic naphthas, and active amine sulfonates. Other paraffin dispersants are also possible and will be known to those skilled in the art.

The paraffin dispersant may be present in the composition in any suitable amount. In some embodiments, the paraffin dispersant is present in the composition in an amount ranging between 0.01 wt % and about 15 wt %. In some cases, the surfactant is present in the composition in an amount of at least about 0.01 wt %, at least about 0.05 to wt %, at least about 0.1 wt %, at least about 0.5 wt %, at least about 1 wt %, at least about 5 wt %, or at least about 10 wt % versus the total composition weight. In certain embodiments, the paraffin dispersant is present in the composition in an amount less than or equal to about 15 wt %, less than or equal to about 10 wt %, less than or equal to about 5 wt %, less than or equal to about 1 wt %, less than or equal to about 0.5 wt %, or less than or equal to about 0.1 wt % versus the total composition weight. Combinations of the above-reference ranges are also possible (e.g., between about 0.1 wt % and about 15 wt %, between about 0.1 wt % and about 10 wt %, between about 5 wt % and about 15 wt %). Other ranges are also possible.

Fluids comprising a second component (e.g., comprising a structure as in Formula (I)) and a solvent (e.g., a terpene) as described herein may be used to remove a hydrocarbon (e.g., asphaltenes, tars and/or heavy oils) from a surface. The method generally comprises contacting a surface associated with a hydrocarbon (e.g., asphaltenes, tars and/or heavy oils) with the fluid such that the hydrocarbon disassociates from the surface. In an exemplary embodiments, the hydrocarbon is paraffin. In another exemplary embodiment, the hydrocarbon is asphaltene.

In some embodiments, the dissociated hydrocarbon (e.g., comprising oil and/or grease) may be removed from the surface by wiping the surface (e.g., with a cloth) or rinsing the surface (e.g., with water or a solvent).

In some embodiments, the surface may be a surface of a tool (e.g., wellbore equipment). In certain embodiments, the surface is a cooking surface (e.g., a surface of a utensil, a surface of a cooking counter, a surface of an oven, a surface of a sink, etc.). In some cases, the surface may be a surface of an automotive part. In some embodiments, the surface may be a surface of above-ground oil and/or gas equipment such as well heads, rig washers, truck parts, or the like. Those skilled in the art would be capable of selecting suitable surfaces (e.g., associated with a hydrocarbon) based upon the teachings of the specification. For example, in some embodiments, the surface comprises a metal (e.g., iron, alloys of iron such as steel, stainless steel, cast iron, or the like. aluminum, titanium, copper, magnesium, zinc, precious metals such as gold, silver, platinum, palladium, or the like).

In some embodiments the surface may be located in a wellbore of an oil and/or gas well. Any suitable method for injecting a fluid and/or a composition comprising the fluid into a wellbore may be employed. For example, in some embodiments, the fluid to may be injected into a subterranean formation by injecting it into a well or wellbore in the zone of interest of the formation and thereafter pressurizing it into the formation for the selected distance. Methods for achieving the placement of a selected quantity of a fluid in a subterranean formation are known in the art. The well may be treated with the fluid for a suitable period of time. The fluid may be removed from the well using known techniques, including producing the well. In some cases, the fluid is dripped (i.e. injected relatively slowly) into the well such that the fluid mixes with the oil and/or paraffin in the wellbore and disassociates the oil and/or paraffin from a surface of the wellbore.

It should be understood, that in embodiments where a fluid (e.g., comprising a second component comprising a structure as in Formula (I) and a solvent) is said to be injected into a wellbore, that the fluid may be combined with other liquid component(s) (e.g., surfactants, solvents, alcohols, paraffin dispersants as described herein) prior to and/or during injection (e.g., via straight tubing, via coiled tubing, etc.). For example, in some embodiments, the fluid is combined with an aqueous phase (e.g., water, brine, sea water, fresh water) prior to and/or during injection into the wellbore.

For convenience, certain terms employed in the specification, examples, and appended claims are listed here.

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

Certain compounds of the present invention may exist in particular geometric or stereoisomeric forms. The present invention contemplates all such compounds, including cis- and trans-isomers, R- and S-enantiomers, diastereomers, (D)-isomers, (L)-isomers, the racemic mixtures thereof, and other mixtures thereof, as falling within the scope of the invention. Additional asymmetric carbon atoms may be present in a substituent such as an alkyl group. All such isomers, as well as mixtures thereof, are intended to be included in this invention.

Isomeric mixtures containing any of a variety of isomer ratios may be utilized in accordance with the present invention. For example, where only two isomers are combined, mixtures containing 50:50, 60:40, 70:30, 80:20, 90:10, 95:5, 96:4, 97:3, 98:2, 99:1, or 100:0 isomer ratios are all contemplated by the present invention. Those of ordinary skill in the art will readily appreciate that analogous ratios are contemplated for more complex isomer mixtures.

The term “aliphatic,” as used herein, includes both saturated and unsaturated, nonaromatic, straight chain (i.e., unbranched), branched, acyclic, and cyclic (i.e., carbocyclic) hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched, and cyclic alkyl groups. An analogous convention applies to other generic terms such as “alkenyl”, “alkynyl”, and the like. Furthermore, as used herein, the terms “alkyl”, “alkenyl”, “alkynyl”, and the like encompass both substituted and unsubstituted groups. In certain embodiments, as used herein, “aliphatic” is used to indicate those aliphatic groups (cyclic, acyclic, substituted, unsubstituted, branched, or unbranched) having 1-20 carbon atoms. Aliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

As used herein, the term “alkyl” is given its ordinary meaning in the art and refers to the radical of saturated aliphatic groups, including straight-chain alkyl groups, branched-chain alkyl groups, cycloalkyl (alicyclic) groups, alkyl substituted cycloalkyl groups, and cycloalkyl substituted alkyl groups. In some cases, the alkyl group may be a lower alkyl group, i.e., an alkyl group having 1 to 10 carbon atoms (e.g., methyl, ethyl, propyl, butyl, pentyl, hexyl, heptyl, octyl, nonyl, or decyl). In some embodiments, a straight chain or branched chain alkyl may have 30 or fewer carbon atoms in its backbone, and, in some cases, 20 or fewer. In some embodiments, a straight chain or branched chain alkyl may have 12 or fewer carbon atoms in its backbone (e.g., C₁-C₁₂ for straight chain, C₃-C₁₂ for branched chain), 6 or fewer, or 4 or fewer. Likewise, cycloalkyls may have from 3-10 carbon atoms in their ring structure, or 5, 6, or 7 carbons in the ring structure. Examples of alkyl groups include, but are not limited to, methyl, ethyl, propyl, isopropyl, cyclopropyl, butyl, isobutyl, t-butyl, cyclobutyl, hexyl, and cyclohexyl.

The term “alkylene” as used herein refers to a bivalent alkyl group. An “alkylene” group is a polymethylene group, i.e., —(CH₂)_{z}—, wherein z is a positive integer, e.g., from 1 to 20, from 1 to 10, from 1 to 6, from 1 to 4, from 1 to 3, from 1 to 2, or from 2 to 3. A substituted alkylene chain is a polymethylene group in which one or more methylene hydrogen atoms are replaced with a substituent. Suitable substituents include those described herein for a substituted aliphatic group.

Generally, the suffix “-ene” is used to describe a bivalent group. Thus, any of the terms defined herein can be modified with the suffix “-ene” to describe a bivalent version of that moiety. For example, a bivalent carbocycle is “carbocyclylene”, a bivalent aryl ring is “arylene”, a bivalent benzene ring is “phenylene”, a bivalent heterocycle is “heterocyclylene”, a bivalent heteroaryl ring is “heteroarylene”, a bivalent alkyl chain is “alkylene”, a bivalent alkenyl chain is “alkenylene”, a bivalent alkynyl chain is “alkynylene”, a bivalent heteroalkyl chain is “heteroalkylene”, a bivalent heteroalkenyl chain is “heteroalkenylene”, a bivalent heteroalkynyl chain is “heteroalkynylene”, and so forth.

The terms “alkenyl” and “alkynyl” are given their ordinary meaning in the art and refer to unsaturated aliphatic groups analogous in length and possible substitution to the alkyls described above, but that contain at least one double or triple bond respectively.

In certain embodiments, the alkyl, alkenyl, and alkynyl groups employed in the invention contain 1-20 aliphatic carbon atoms. In certain other embodiments, the alkyl, alkenyl, and alkynyl groups employed in the invention contain 1-10 aliphatic carbon atoms. In yet other embodiments, the alkyl, alkenyl, and alkynyl groups employed in the invention contain 1-8 aliphatic carbon atoms. In still other embodiments, the alkyl, alkenyl, and alkynyl groups employed in the invention contain 1-6 aliphatic carbon atoms. In yet other embodiments, the alkyl, alkenyl, and alkynyl groups employed in the invention contain 1-4 carbon atoms. Illustrative aliphatic groups thus include, but are not to limited to, for example, methyl, ethyl, n-propyl, isopropyl, allyl, n-butyl, sec-butyl, isobutyl, t-butyl, n-pentyl, sec-pentyl, isopentyl, t-pentyl, n-hexyl, sec-hexyl, moieties and the like, which again, may bear one or more substituents. Alkenyl groups include, but are not limited to, for example, ethenyl, propenyl, butenyl, 1-methyl-2-buten-1-yl, and the like. Representative alkynyl groups include, but are not limited to, ethynyl, 2-propynyl (propargy1), 1-propynyl, and the like.

The term “cycloalkyl,” as used herein, refers specifically to groups having three to ten, preferably three to seven carbon atoms. Suitable cycloalkyls include, but are not limited to cyclopropyl, cyclobutyl, cyclopentyl, cyclohexyl, cycloheptyl and the like, which, as in the case of other aliphatic, heteroaliphatic, or hetercyclic moieties, may optionally be substituted with substituents including, but not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

The term “heteroaliphatic,” as used herein, refers to an aliphatic moiety, as defined herein, which includes both saturated and unsaturated, nonaromatic, straight chain (i.e., unbranched), branched, acyclic, cyclic (i.e., heterocyclic), or polycyclic hydrocarbons, which are optionally substituted with one or more functional groups, and that contain one or more oxygen, sulfur, nitrogen, phosphorus, or silicon atoms, e.g., in place of carbon atoms. In certain embodiments, heteroaliphatic moieties are substituted by independent replacement of one or more of the hydrogen atoms thereon with one or more substituents. As will be appreciated by one of ordinary skill in the art, “heteroaliphatic” is intended herein to include, but is not limited to, heteroalkyl, heteroalkenyl, heteroalkynyl, heterocycloalkyl, heterocycloalkenyl, and to heterocycloalkynyl moieties. Thus, the term “heteroaliphatic” includes the terms “heteroalkyl,” “heteroalkenyl”, “heteroalkynyl”, and the like. Furthermore, as used herein, the terms “heteroalkyl”, “heteroalkenyl”, “heteroalkynyl”, and the like encompass both substituted and unsubstituted groups. In certain embodiments, as used herein, “heteroaliphatic” is used to indicate those heteroaliphatic groups (cyclic, acyclic, substituted, unsubstituted, branched, or unbranched) having 1-20 carbon atoms. Heteroaliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, sulfinyl, sulfonyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “heteroalkyl” is given its ordinary meaning in the art and refers to an alkyl group as described herein in which one or more carbon atoms is replaced by a heteroatom. Suitable heteroatoms include oxygen, sulfur, nitrogen, phosphorus, and the like. Examples of heteroalkyl groups include, but are not limited to, alkoxy, alkoxyalkyl, amino, thioester, poly(ethylene glycol), and alkyl-substituted amino.

The terms “heteroalkenyl” and “heteroalkynyl” are given their ordinary meaning in the art and refer to unsaturated aliphatic groups analogous in length and possible substitution to the heteroalkyls described above, but that contain at least one double or triple bond respectively.

Some examples of substituents of the above-described aliphatic (and other) moieties of compounds of the invention include, but are not limited to aliphatic; heteroaliphatic; aryl; heteroaryl; alkylaryl; alkylheteroaryl; alkoxy; aryloxy; heteroalkoxy; heteroaryloxy; alkylthio; arylthio; heteroalkylthio; heteroarylthio; F; Cl; Br; I; —OH; —NO₂; —CN; —CF₃; —CHF₂; —CH₂F; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ wherein each occurrence of Rₓ independently includes, but is not limited to, aliphatic, alycyclic, heteroaliphatic, heterocyclic, aryl, heteroaryl, alkylaryl, or alkylheteroaryl, wherein any of the aliphatic, heteroaliphatic, alkylaryl, or alkylheteroaryl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

The term “aryl” is given its ordinary meaning in the art and refers to aromatic carbocyclic groups, optionally substituted, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls, and/or heterocyclyls. The aryl group may be optionally substituted, as described herein. Substituents include, but are not limited to, any of the previously mentioned substituents, i.e., the substituents recited for aliphatic moieties, or for other moieties as disclosed herein, resulting in the formation of a stable compound. In some cases, an aryl group is a stable mono- or polycyclic unsaturated moiety having preferably 3-14 carbon atoms, each of which may be substituted or unsubstituted. “Carbocyclic aryl groups” refer to aryl groups wherein the ring atoms on the aromatic ring are carbon atoms. Carbocyclic aryl groups include monocyclic carbocyclic aryl groups and polycyclic or fused compounds (e.g., two or more adjacent ring atoms are common to two adjoining rings) such as naphthyl groups.

The terms “heteroaryl” is given its ordinary meaning in the art and refers to aryl groups comprising at least one heteroatom as a ring atom. A “heteroaryl” is a stable heterocyclic or polyheterocyclic unsaturated moiety having preferably 3-14 carbon atoms, each of which may be substituted or unsubstituted. Substituents include, but are not limited to, any of the previously mentioned substituents, i.e., the substitutes recited for aliphatic moieties, or for other moieties as disclosed herein, resulting in the formation of a stable compound. In some cases, a heteroaryl is a cyclic aromatic radical having from five to ten ring atoms of which one ring atom is selected from S, O, and N; zero, one, or two ring atoms are additional heteroatoms independently selected from S, O, and N; and the remaining ring atoms are carbon, the radical being joined to the rest of the molecule via any of the ring atoms, such as, for example, pyridyl, pyrazinyl, pyrimidinyl, pyrrolyl, pyrazolyl, imidazolyl, thiazolyl, oxazolyl, isooxazolyl, thiadiazolyl,oxadiazolyl, thiophenyl, furanyl, quinolinyl, isoquinolinyl, and the like.

It will also be appreciated that aryl and heteroaryl moieties, as defined herein may be attached via an alkyl or heteroalkyl moiety and thus also include -(alkyl)aryl, -(heteroalkyl)aryl, -(heteroalkyl)heteroaryl, and -(heteroalkyl)heteroaryl moieties. Thus, as used herein, the phrases “aryl or heteroaryl moieties” and “aryl, heteroaryl, -(alkyl)aryl, -(heteroalkyl)aryl, -(heteroalkyl)heteroaryl, and -(heteroalkyl)heteroaryl” are interchangeable. Substituents include, but are not limited to, any of the previously mentioned substituents, i.e., the substituents recited for aliphatic moieties, or for other moieties as disclosed herein, resulting in the formation of a stable compound.

It will be appreciated that aryl and heteroaryl groups (including bicyclic aryl groups) can be unsubstituted or substituted, wherein substitution includes replacement of one or more of the hydrogen atoms thereon independently with any one or more of the following moieties including, but not limited to: aliphatic; alicyclic; heteroaliphatic; heterocyclic; aromatic; heteroaromatic; aryl; heteroaryl; alkylaryl; heteroalkylaryl; alkylheteroaryl; heteroalkylheteroaryl; alkoxy; aryloxy; heteroalkoxy; heteroaryloxy; alkylthio; arylthio; heteroalkylthio; heteroarylthio; F; Cl; Br; I; —OH; —NO₂; —CN; —CF₃; —CH₂F; —CHF₂; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)Rₓ; —S(O)₂Rₓ; —NRₓ(CO)Rₓ wherein each occurrence of Rₓ independently includes, but is not limited to, aliphatic, alicyclic, heteroaliphatic, heterocyclic, aromatic, heteroaromatic, aryl, heteroaryl, alkylaryl, alkylheteroaryl, heteroalkylaryl or heteroalkylheteroaryl, wherein any of the aliphatic, alicyclic, heteroaliphatic, heterocyclic, alkylaryl, or alkylheteroaryl substituents described above and herein may be substituted or unsubstituted, branched or unbranched, saturated or unsaturated, and wherein any of the aromatic, heteroaromatic, aryl, heteroaryl, -(alkyl)aryl or -(alkyl)heteroaryl substituents described above and herein may be substituted or unsubstituted. Additionally, it will be appreciated, that any two adjacent groups taken together may represent a 4, 5, 6, or 7-membered substituted or unsubstituted alicyclic or heterocyclic moiety. Additional examples of generally applicable substituents are illustrated by the specific embodiments described herein.

The term “heterocycle” is given its ordinary meaning in the art and refers to refer to cyclic groups containing at least one heteroatom as a ring atom, in some cases, 1 to 3 heteroatoms as ring atoms, with the remainder of the ring atoms being carbon atoms. Suitable heteroatoms include oxygen, sulfur, nitrogen, phosphorus, and the like. In some to cases, the heterocycle may be 3- to 10-membered ring structures or 3- to 7-membered rings, whose ring structures include one to four heteroatoms.

The term “heterocycle” may include heteroaryl groups, saturated heterocycles (e.g., cycloheteroalkyl) groups, or combinations thereof. The heterocycle may be a saturated molecule, or may comprise one or more double bonds. In some cases, the heterocycle is a nitrogen heterocycle, wherein at least one ring comprises at least one nitrogen ring atom. The heterocycles may be fused to other rings to form a polycylic heterocycle. The heterocycle may also be fused to a spirocyclic group. In some cases, the heterocycle may be attached to a compound via a nitrogen or a carbon atom in the ring.

Heterocycles include, for example, thiophene, benzothiophene, thianthrene, furan, tetrahydrofuran, pyran, isobenzofuran, chromene, xanthene, phenoxathiin, pyrrole, dihydropyrrole, pyrrolidine, imidazole, pyrazole, pyrazine, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, triazole, tetrazole, oxazole, isoxazole, thiazole, isothiazole, phenanthridine, acridine, pyrimidine, phenanthroline, phenazine, phenarsazine, phenothiazine, furazan, phenoxazine, pyrrolidine, oxolane, thiolane, oxazole, oxazine, piperidine, homopiperidine (hexamnethyleneimine), piperazine (e.g., N-methyl piperazine), morpholine, lactones, lactams such as azetidinones and pyrrolidinones, sultams, sultones, other saturated and/or unsaturated derivatives thereof, and the like. The heterocyclic ring can be optionally substituted at one or more positions with such substituents as described herein. In some cases, the heterocycle may be bonded to a compound via a heteroatom ring atom (e.g., nitrogen). In some cases, the heterocycle may be bonded to a compound via a carbon ring atom. In some cases, the heterocycle is pyridine, imidazole, pyrazine, pyrimidine, pyridazine, acridine, acridin-9-amine, bipyridine, naphthyridine, quinoline, benzoquinoline, benzoisoquinoline, phenanthridine-1,9-diamine, or the like.

The terms “halo” and “halogen” as used herein refer to an atom selected from the group consisting of fluorine, chlorine, bromine, and iodine.

The term “haloalkyl” denotes an alkyl group, as defined above, having one, two, or three halogen atoms attached thereto and is exemplified by such groups as chloromethyl, bromoethyl, trifluoromethyl, and the like.

The term “amino,” as used herein, refers to a primary (—NH₂), secondary (—NHRₓ), tertiary (—NRₓR_{y}), or quaternary (—N⁺RₓR_{y}R_{z}) amine, where Rₓ, R_{y}, and R_{z} are independently an aliphatic, alicyclic, heteroaliphatic, heterocyclic, aryl, or heteroaryl moiety, as defined herein. Examples of amino groups include, but are not limited to, methylamino, dimethylamino, ethylamino, diethylamino, methylethylamino, iso-propylamino, piperidino, trimethylamino, and propylamino.

The term “alkoxy” (or “alkyloxy”), or “thioalkyl” as used herein refers to an alkyl group, as previously defined, attached to the parent molecular moiety through an oxygen atom or through a sulfur atom. In certain embodiments, the alkyl group contains 1-20 aliphatic carbon atoms. In certain other embodiments, the alkyl group contains 1-10 aliphatic carbon atoms. In yet other embodiments, the alkyl, alkenyl, and alkynyl groups employed in the invention contain 1-8 aliphatic carbon atoms. In still other embodiments, the alkyl group contains 1-6 aliphatic carbon atoms. In yet other embodiments, the alkyl group contains 1-4 aliphatic carbon atoms. Examples of alkoxy, include but are not limited to, methoxy, ethoxy, propoxy, isopropoxy, n-butoxy, t-butoxy, neopentoxy, and n-hexoxy. Examples of thioalkyl include, but are not limited to, methylthio, ethylthio, propylthio, isopropylthio, n-butylthio, and the like.

The term “aryloxy” refers to the group, —O-aryl.

The term “acyloxy” refers to the group, —O-acyl.

The term “alkoxyalkyl” refers to an alkyl group substituted with at least one alkoxy group (e.g., one, two, three, or more, alkoxy groups). For example, an alkoxyalkyl group may be —(C₁₋₆-alkyl)-O—(C₁₋₆-alkyl), optionally substituted. In some cases, the alkoxyalkyl group may be optionally substituted with another alkyoxyalkyl group (e.g., —(C₁₋₆-alkyl)-O—(C₁₋₆-alkyl)-O—(C₁₋₆-alkyl), optionally substituted. As used herein, the term “phosphine” is given its ordinary meaning in the art and refers to a group comprising at least one phosphorus atom. The phosphorus atom may bear one, two, or three aliphatic or aromatic groups, optionally substituted and optionally comprising at least one heteroatom.

It will be appreciated that the above groups and/or compounds, as described herein, may be optionally substituted with any number of substituents or functional moieties. That is, any of the above groups may be optionally substituted. As used herein, the term “substituted” is contemplated to include all permissible substituents of organic compounds, “permissible” being in the context of the chemical rules of valence to known to those of ordinary skill in the art. In general, the term “substituted” whether proceeded by the term “optionally” or not, and substituents contained in formulas of this invention, refer to the replacement of hydrogen radicals in a given structure with the radical of a specified substituent. When more than one position in any given structure may be substituted with more than one substituent selected from a specified group, the substituent may be either the same or different at every position. It will be understood that “substituted” also includes that the substitution results in a stable compound, e.g., which does not spontaneously undergo transformation such as by rearrangement, cyclization, elimination, etc. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl group” must still comprise the phenyl moiety and cannot be modified by substitution, in this definition, to become, e.g., a pyridine ring. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. Furthermore, this invention is not intended to be limited in any manner by the permissible substituents of organic compounds. Combinations of substituents and variables envisioned by this invention are preferably those that result in the formation of stable compounds useful for the formation of an imaging agent or an imaging agent precursor. The term “stable,” as used herein, preferably refers to compounds which possess stability sufficient to allow manufacture and which maintain the integrity of the compound for a sufficient period of time to be detected and preferably for a sufficient period of time to be useful for the purposes detailed herein.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, -carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy-, aminocarboxamidoalkyl-, cyano, alkoxyalkyl, perhaloalkyl, arylalkyloxyalkyl, and the like.

These and other aspects of the present invention will be further appreciated upon consideration of the following Examples, which are intended to illustrate certain particular embodiments of the invention but are not intended to limit its scope, as defined by the claims.

### EXAMPLES

### Example 1

The following example demonstrates the flash point of fluids described herein, as determined by ASTM D7094.

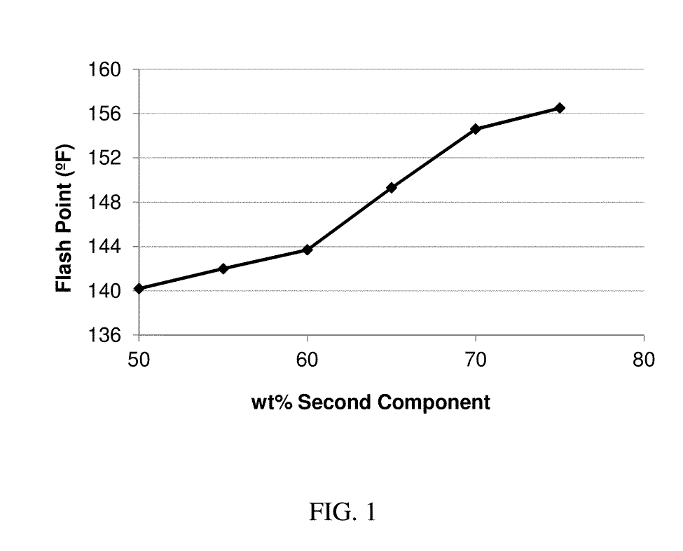

FIG. 1 is a plot of the flash point of various mixtures of a terpene solvent (e.g., d-limonene) and a second component (e.g., an unsaturated alkyl methyl ester with 11 degrees of saturation) as a function of weight percent of the second component. 100% d-limonene had a flash point of approximately 122° F. 100% of the second component had a flashpoint of approximately 260.6° F.

### Example 2

The following example demonstrates the efficacy of fluids described herein to disperse asphaltene.

Samples were prepared by adding a predetermined amount of the desired asphaltene sample to a 4-dram vial. The amount used for the test depended on the asphaltene sample used. For asphaltene sample #1, 0.8000±0.005 g were used while for asphaltene sample #2 1.000±0.005 g were used. To begin the test, 10.0 mL of the desired solvent was pipetted into the vial and the sample was then mixed for a predetermined time. The amount of time the sample was mixed depended on the asphaltene sample used. After the time was up, the sample liquid was then filtered via a5 μm syringe filter into a pre-labeled vial. Analysis to determine the asphaltene concentration in the sample was done using a spectrophotometer. Generally, the relationship between concentration of a compound in a solution and the absorption wavelength follows Beer's Law as in:

A_{λ}=(ε_{λ})( [symbol] )(c_{λ}),

where ε_{λ} is the molar extinction coefficient at a particular wavelength, [symbol] is the path length of the cell holder at a specific wavelength and c_{λ} is the concentration of the solution at a particular wavelength. Generally, a sample that has a higher absorbance at a specific wavelength will have a high concentration of the chemical that causes it to absorb at that wavelength.

To prepare the sample for spectroscopic analysis, a dilution of the sample was done using Technical Grade d-Limonene. The absorbance of the diluted sample at 400 nm was then measured using a dual beam UV-vis spectrophotometer. Using a calibration curve, the concentration of the diluted sample (C_{dilution}) was determined:

$${C}_{dilution} = \frac{{A}_{400 nm}}{{S}_{calibration}}$$

where A_{400 nm} was the absorbance of the diluted sample at 400 nm, and S_{calibration} was the slope of the calibration curve. A calibration curve was performed for each asphaltene sample tested. The asphaltene concentration of the undiluted sample was determined by:

$${C}_{sample} = {C}_{dilution} \times ( \frac{{V}_{sample} + {V}_{diluent}}{{V}_{sample}} )$$

where Vₛₐₘₚₗₑ was the volume of sample used to make the diluted sample, and V_{diluent} was the volume of d-Limonene used to dilute the sample.

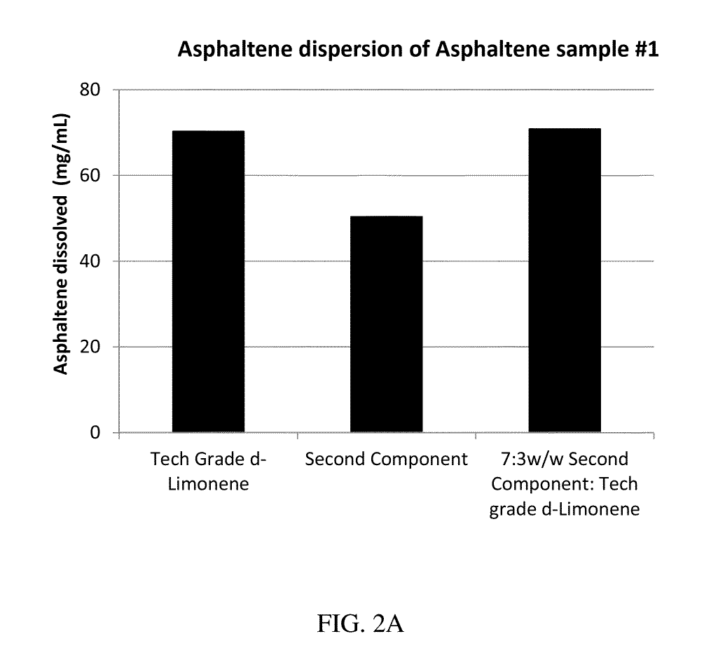

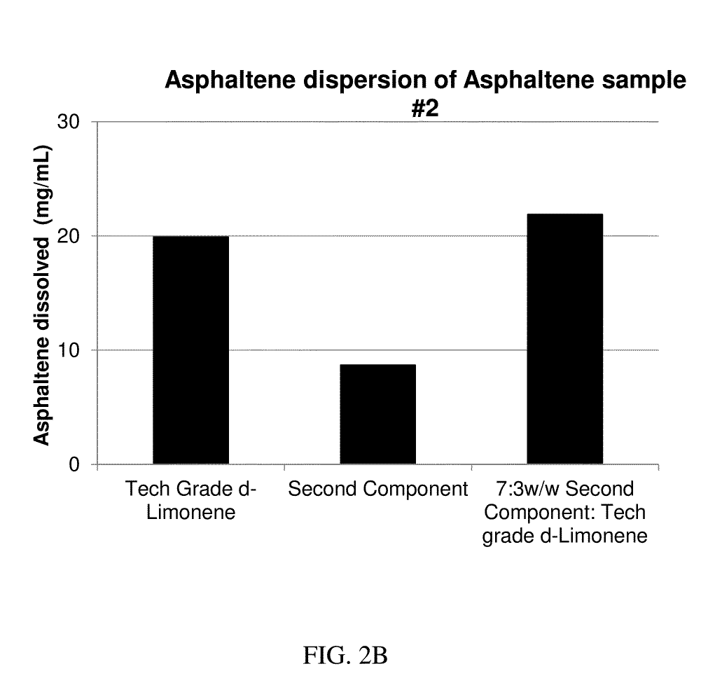

FIGS. 2A-2B are plots of the dispersion of asphaltene for d-limonene, an unsaturated alkyl methyl ester of 11 degrees of saturation, and a 30:70 wt % mixture of d-limonene and the unsaturated alkyl methyl ester.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e. elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e. the inclusion of at least one, but also including more than one, of a number or list of elements, and, optionally, additional unlisted items. Only terms clearly indicated to the contrary, such as “only one of” or “exactly one of,” or, when used in the claims, “consisting of,” will to refer to the inclusion of exactly one element or a list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e. to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A fluid comprising:
a terpene; and
a second component comprising a structure as in Formula (I): 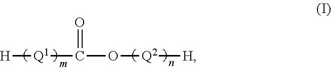
wherein each Q¹ and Q² are the same or different and are selected from the group consisting of optionally substituted alkylenes, optionally substituted alkenylenes, optionally substituted alkynylenes, optionally substituted heteroalkylenes, optionally substituted arylenes, and optionally substituted heteroarylenes, wherein the second component has a degree of unsaturation between 0-17;
wherein m is 4-33, n is 1-10, and m+n is 9-34;
wherein the fluid comprises X wt % of the second component versus the total fluid weight, wherein X is between about 50 and about 99;
wherein the fluid comprises (100-X) wt % of the terpene versus the total fluid weight; and
wherein the fluid has a flash point of at least about 140° F.

2. The fluid of claim 1, wherein the terpene is d-limonene.

3. The fluid of claim 1, wherein the terpene is pinene.

4. The fluid of claim 1, wherein the terpene is α-pinene.

5. The fluid of claim 1, wherein each Q¹ and Q² are the same or different and are selected from the group consisting of optionally substituted alkylenes, optionally substituted alkenylenes, optionally substituted alkynylenes, and optionally substituted arylenes.

6. The fluid of claim 1, wherein each Q¹ and Q² are the same or different and are selected from the group consisting of optionally substituted alkylenes, optionally substituted alkenylenes, and optionally substituted alkynylenes.

7. The fluid of claim 1, wherein each Q¹ and Q² is the same or different and is —CH₂—, —CH((CH₂)ₓH)—, —CH═CH—, or —C≡C—, wherein x is 1-10.

8. The fluid of claim 1, wherein 0-17 of Q¹ and Q² is —CH═CH—, or arylene.

9. The fluid of claim 1, wherein 6-17 of Q¹ and Q² are —CH=CH—.

10. The fluid of claim 1, wherein X is between about 50 and about 75.

11. The fluid of claim 1, wherein the is essentially free of volatile organic compounds.

12. The fluid of claim 1, wherein the flash point is determined by ASTM D7094.

13. The fluid of claim 1, wherein the second component is not substituted with nitrogen and/or alcohol functional groups.

14. The fluid of claim 1, wherein the second component has a total carbon length of 10-35 carbons.

15. The fluid of claim 1, wherein m+n is 18-30.

16. A composition, comprising:
the fluid of claim 1; and
one or more additives.

17. The composition of claim 16, wherein the one or more additives comprise a surfactant.

18. The composition of claim 16, wherein the one or more additives comprise an alcohol.

19. The composition of claim 16, wherein the one or more additives comprise a paraffin dispersant.

20. The composition of claim 16, wherein the surfactant is present in the composition in an amount ranging between about 0.1 wt % and about 75 wt % versus the total composition weight.

21. The composition of claim 16, wherein the alcohol is present in the composition in an amount ranging between about 0.1 wt % and about 25 wt % versus the total composition weight.

22. The composition of claim 16, wherein the alcohol is present in the composition in an amount ranging between about 0.1 wt % and about 15 wt % versus the total composition weight.

23. A method, comprising:
contacting a surface associated with a hydrocarbon with the fluid of claim 1, such that the hydrocarbon disassociates from the surface.

24. A method, comprising:
contacting a surface associated with a hydrocarbon with the composition of claim 16, such that the hydrocarbon disassociates from the surface.

24. (canceled)

25. The method of claim 23, wherein the hydrocarbon comprises asphaltene.

26. The method of claim 23, wherein the surface is a surface of a wellbore of an oil and/or gas field, and/or related equipment.

27. The method of claim 23, wherein the surface comprises a metal.

28. The method of claim 23, wherein the hydrocarbon comprises heavy oil.
